(19) United States
(12) Patent Application Publication
(10) Pub. No.: US 2012/0119990 A1
(43) Pub. Date: May 17, 2012

(54) POINTER CONTROL DEVICE, SYSTEM AND METHOD

(75) Inventor: Chih-Min LIU, Taipei (TW)

(73) Assignee: KYE SYSTMES CORP., Taipei (TW)

(21) Appl. No.: 12/944,780

(22) Filed: Nov. 12, 2010

(51) Int. Cl. G06F 3/033

(52) U.S. Cl. 345/158; 178/18.01

(57) ABSTRACT

A pointer control system includes a pointer control device and a pointer sensing device. The pointer control device includes two coils. The two coils respectively transmit a first signal and a second signal to the pointer sensing device, so that the pointer sensing device senses a first coordinate and a second coordinate. The pointer sensing device outputs a control signal which is corresponding to a distance between the first coordinate and the second coordinate. Therefore, the pointer control system can use an angle formed between the pointer control device and the pointer sensing device to control the operation mode of the pointer.

### BACKGROUND OF THE INVENTION

1. Field of Invention

The present invention relates to a pointer control device, system and method, and more particularly to a pointer control device, system and method that use an angle formed between the pointer control device and a pointer sensing device to control a pointer.

2. Related Art

With the development of information technology, more and more related electronic products are developed to meet the demand of the market, and make computers easier to be operated by users. The current pointer control systems are mainly mouse and Tablet systems, which can be decided by the user according to actual demands. For example, if the user needs to operate the graphic software, the user may select the Tablet system so as to draw a picture.

The conventional Tablet system includes a Tablet and a digital pen, which are used to control the operation mode of the pointer in the computer. A coil is provided in the digital pen, and antenna loops arranged at equal intervals in an X, Y-axis array mode are disposed in a working area of the Tablet. The antenna loops are used for receiving frequency signals sent by the digital pen, and analyzing and processing the received frequency signals by a processing unit, so as to decide the coordinate position of the digital pen relative to the Tablet, and to further perform the functions of scrolling, clicking or tracing.

When the conventional Tablet system is applied in the operation of the graphic software, the coil changes the frequency of the frequency signal which is sent by the coil as the force of the pen point of the digital pen that touches the Tablet changes, so that lines of different thicknesses are produced on the computer screen. However, this method requires great effort from the user to draw thick lines, and meanwhile when the user draws the thick lines with great effort, the Tablet and the digital pen may easily be damaged due to the friction in-between.

In addition, when the user operates the conventional Tablet system and the digital pen is static on the Tablet, the mere change of the angle formed between the digital pen and the Tablet may lead to the displacement of the pointer on the computer screen, which will cause an operation error.

### SUMMARY OF THE INVENTION

Accordingly, the present invention is a pointer control device, system and method, which solve the problem that it takes great effort and is likely to cause abrasion between the Tablet and the digital pen when the user draws thick lines with the conventional pointer control system, and also solve the problem in the conventional pointer control system that the mere change of the angle formed between the digital pen and the Tablet may lead to the displacement of the pointer.

According to an embodiment of the pointer control device disclosed in the present invention, the pointer control device is applied in a pointer sensing device, and the pointer control device comprises two coils. The two coils respectively transmit a first signal and a second signal to the pointer sensing device, so that the pointer sensing device is enabled to sense a first coordinate and a second coordinate respectively. The first coordinate and the second coordinate are respectively absolute coordinates of the two coils on the pointer sensing device when the two coils send the first signal and the second signal. In this embodiment, the angle formed between the pointer control device and the pointer sensing device may range from zero to 90 degrees. When the angle formed between the pointer control device and the pointer sensing device is larger, the distance between the first coordinate and the second coordinate is shorter. When the angle formed between the pointer control device and the pointer sensing device is smaller, the distance between the first coordinate and the second coordinate is longer. When the angle is 90 degrees, the first coordinate coincides with the second coordinate.

According to an embodiment of the pointer control system disclosed in the present invention, the pointer control system is applied to control a pointer. The pointer control system comprises a pointer sensing device and a pointer control device. The pointer sensing device comprises a predetermined value, and the pointer control device comprises two coils. The two coils respectively transmit a first signal and a second signal to the pointer sensing device, so that the pointer sensing device is enabled to sense a first coordinate and a second coordinate respectively. The pointer sensing device obtains an inclination angle value according to a relativity between the first coordinate and the second coordinate, compares the inclination angle value with the predetermined value, and further outputs a control signal which is corresponding to the result of the comparison between the inclination angle value and the predetermined value. When the inclination angle value is larger than the predetermined value, the pointer sensing device outputs a first control signal; while when the inclination angle value is smaller than or equal to the predetermined value, the pointer sensing device outputs a second control signal. In this embodiment, the inclination angle value may be a numerical value that indicates the angle formed between the pointer sensing device and the pointer control device.

According to an embodiment of the pointer control method disclosed in the present invention, the pointer control method comprises: receiving a first signal and a second signal transmitted by two coils respectively; sensing a first coordinate and a second coordinate according to the first signal and the second signal; and outputting a control signal which is corresponding to a distance between the first coordinate and the second coordinate. When the frequencies of the first signal and the second signal are different, the first signal and the second signal are received at the same time. When the frequencies of the first signal and the second signal are identical, the first signal and the second signal are received at different times.

According to the pointer control device, system and method disclosed in the present invention, the operation mode of the pointer can be controlled through outputting the control signal which is corresponding to the distance between the first coordinate and the second coordinate that are sensed by the pointer sensing device. Therefore, the pointer control device, system and method of the present invention can solve the problem that it takes great effort and is likely to cause abrasion between the Tablet and the digital pen when the user draws thick lines with the conventional pointer control system, and also solve the problem in the conventional pointer control system that the mere change of the angle formed between the digital pen and the Tablet may lead to the displacement of the pointer. When the frequencies of the first signal and the second signal sent by the two coils are different, the first signal and the second signal are received by the pointer sensing device at the same time. When the frequencies of the first signal and the second signal sent by the two coils are identical, the first signal and the second signal are received by the pointer sensing device at different times through a control unit of the pointer control device, so as to avoid interference with each other.

### BRIEF DESCRIPTION OF THE DRAWINGS

The present invention will become more fully understood from the detailed description given herein below for illustration only, and thus are not limitative of the present invention, and wherein:

FIG. 1 is a schematic three-dimensional structural view of an embodiment of a pointer control system according to the present invention;

FIG. 2 is a circuit block diagram of an embodiment of the pointer control system according to the present invention;

FIG. 3 is a flow chart of a pointer control method according to FIG. 2;

FIG. 4 is a schematic three-dimensional structural view of another embodiment of the pointer control system according to the present invention;

FIG. 5 is a circuit block diagram of another embodiment of the pointer control system according to the present invention; and

FIG. 6 is a flow chart of a pointer control method according to FIG. 5.

### DETAILED DESCRIPTION OF THE INVENTION

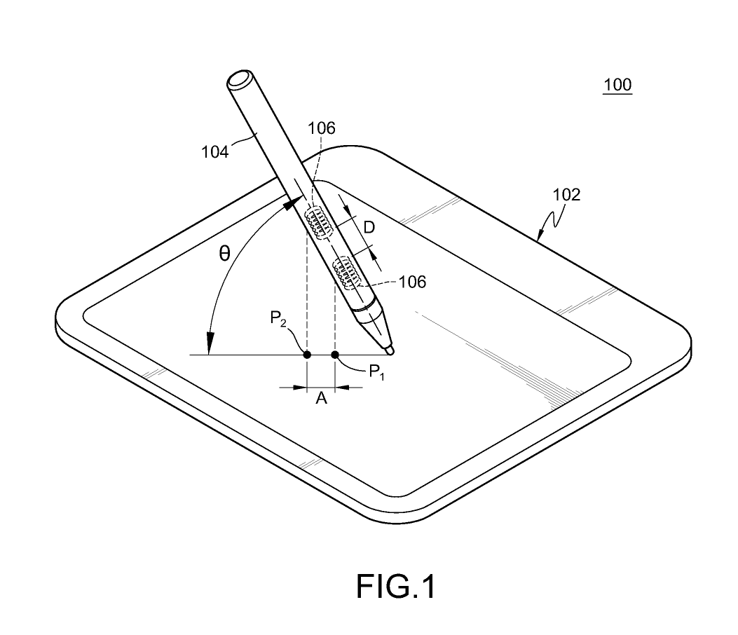

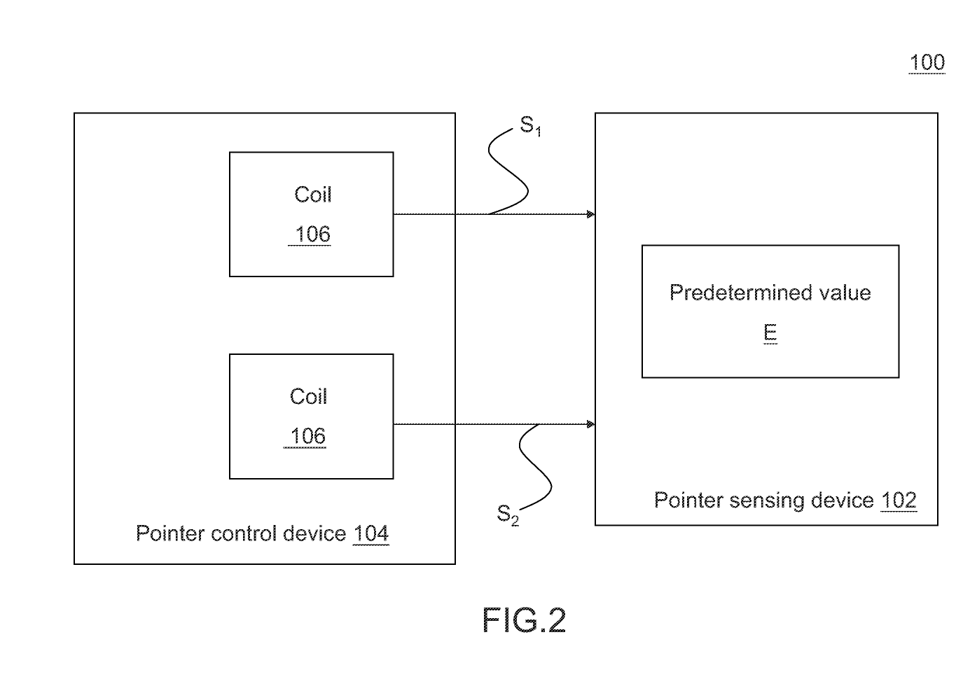

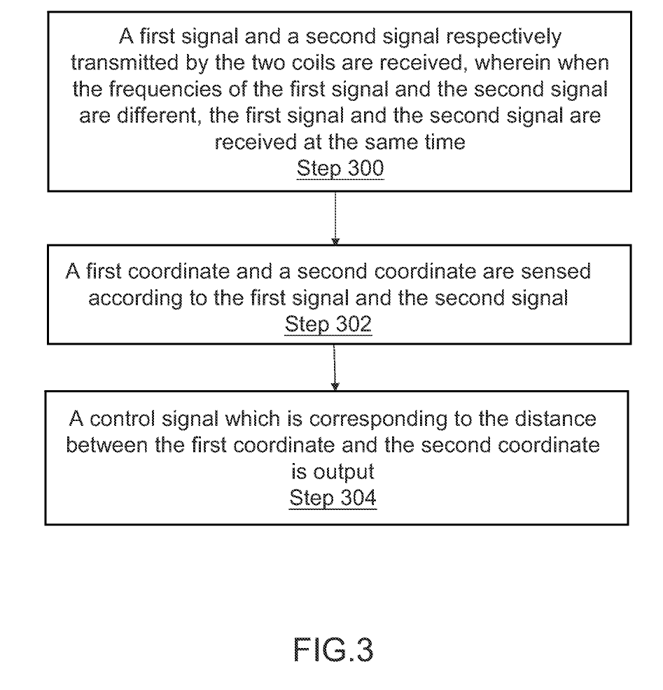

FIG. 1, FIG. 2 and FIG. 3 are respectively a schematic three-dimensional structural view of an embodiment of a pointer control system according to the present invention, a circuit block diagram of the pointer control system, and a flow chart of a pointer control method according to FIG. 2. The pointer control system 100 is applied to control a pointer (not shown), and comprises a pointer sensing device 102 and a pointer control device 104. The pointer sensing device 102 may be, but not limited to, a wireless Tablet, and the pointer control device 104 may be, but not limited to, a wireless digital pen. The pointer control system 104 comprises two coils 106, and the two coils 106 are spaced by a distance D. A first signal S₁ and a second signal S₂ respectively transmitted by the two coils 106 are received, wherein when the frequencies of the first signal S₁ and the second signal S₂ are different, the first signal S₁ and the second signal S₂ are received at the same time (Step 300). In other words, the pointer sensing device 102 receives the first signal S₁ and the second signal S₂ respectively transmitted by the two coils 106, and since the frequencies of the first signal S₁ and the second signal S₂ are different, the first signal S₁ and the second signal S₂ can be received by the pointer sensing device 102 at the same time. However, this embodiment is not intended to limit the present invention.

A first coordinate P₁ and a second coordinate P₂ are sensed according to the first signal S₁ and the second signal S₂ (Step 302). In other words, after receiving the first signal S₁ and the second signal S₂, the pointer sensing device 102 senses the first coordinate P₁ and the second coordinate P₂. The first coordinate P₁ and the second coordinate P₂ are respectively absolute coordinates of the two coils 106 on the pointer sensing device 102 when the two coils 106 send the first signal S₁ and the second signal S₂. Since the two coils 106 are spaced by a distance D, when an angle θ is formed between the pointer sensing device 102 and the pointer control device 104, a distance A exists between the first coordinate P₁ and the second coordinate P₂.

A control signal which is corresponding to the distance A between the first coordinate P₁ and the second coordinate P₂ is output (Step 304). In other words, the pointer sensing device 102 obtains an inclination angle value (not shown) according to the distance A, and further outputs the control signal (not shown) which is corresponding to the inclination angle value. Since the pointer sensing device 102 outputs the control signal which is corresponding to the distance A, the angle θ formed between the pointer control device 104 and the pointer sensing device 102 may range from zero to 90 degrees. When the angle θ formed between the pointer control device 104 and the pointer sensing device 102 is larger, the distance A between the first coordinate P₁ and the second coordinate P₂ is shorter. When the angle θ formed between the pointer control device 104 and the pointer sensing device 102 is smaller, the distance A between the first coordinate P₁ and the second coordinate P₂ is longer. When the angle θ is 90 degrees, the first coordinate P₁ coincides with the second coordinate P₂.

In this embodiment, the pointer sensing device 102 may comprise, but is not limited to, a predetermined value E. When the inclination angle value is larger than the predetermined value E, the pointer sensing device 102 outputs a first control signal (not shown). When the inclination angle value is smaller than or equal to the predetermined value E, the pointer sensing device 102 outputs a second control signal (not shown). The inclination angle value may be a numerical value that indicates the angle θ formed between the pointer sensing device 102 and the pointer control device 104. The predetermined value E may be a numerical value indicating that the angle formed between the pointer sensing device 102 and the pointer control device 104 is 90 degrees. However, to meet the operation habits of the user (since the user cannot continuously operate in a mode that the angle θ formed between the pointer sensing device 102 and the pointer control device 104 is 90 degrees), in this embodiment, the predetermined value E may be a numerical value indicating that the angle θ formed between the pointer sensing device 102 and the pointer control device 104 is 45 degrees. However, this embodiment is not intended to limit the present invention, and adjustments of the predetermined value E can be made according to the actual operation habits of the user. When the angle θ formed between the pointer sensing device 102 and the pointer control device 104 is smaller, the inclination angle value may be smaller; while when the angle θ formed between the pointer sensing device 102 and the pointer control device 104 is larger, the inclination angle value may be greater. This embodiment is not intended to limit the present invention.

For example, the first control signal may maintain the operation mode of the pointer. More specifically, when the pointer control system 100 is applied to control a pointer in the graphic software, where the pointer is originally in a pencil mode, the pointer is still in the pencil mode when the pointer sensing device 102 outputs the first control signal, so as to meet the operation habits of the user. The second control signal may alter the operation mode of the pointer. More specifically, when the pointer control system 100 is applied to control the pointer in the graphic software, where the pointer is originally in the pencil mode, the pointer is changed into a watercolor pen mode when the pointer sensing device 102 outputs the second control signal. However, this embodiment is not intended to limit the present invention, and the first control signal and the second control signal may be adjusted according to actual demands.

In other words, the first control signal and the second control signal may be used for other purposes. For example, when the pointer control device 104 is static on the pointer sensing device 102, the mere change of the angle θ formed between the pointer control device 104 and the pointer sensing device 102 may lead to the displacement of the pointer, which causes inconvenience for the user. While the output of the first control signal and the second control signal can be fed back and control the pointer not to make any displacement. Furthermore, the first control signal enables the pointer control system 100 applied in the operation of the graphic software to draw thin lines, and the second control signal enables the pointer control system 100 applied in the operation of the graphic software to draw thick lines, so as to solve the problem that it takes great effort and is likely to cause damages to the pointer control device and the pointer sensing device when the conventional pointer control system is used for drawing thick lines.

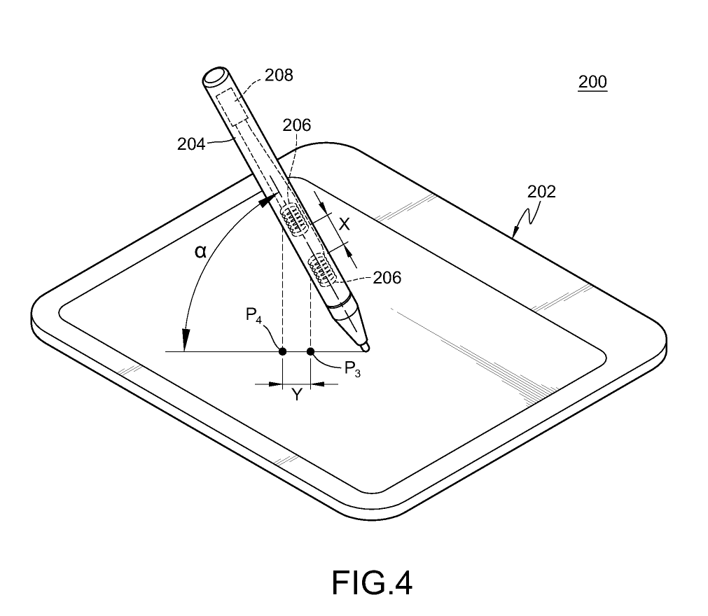

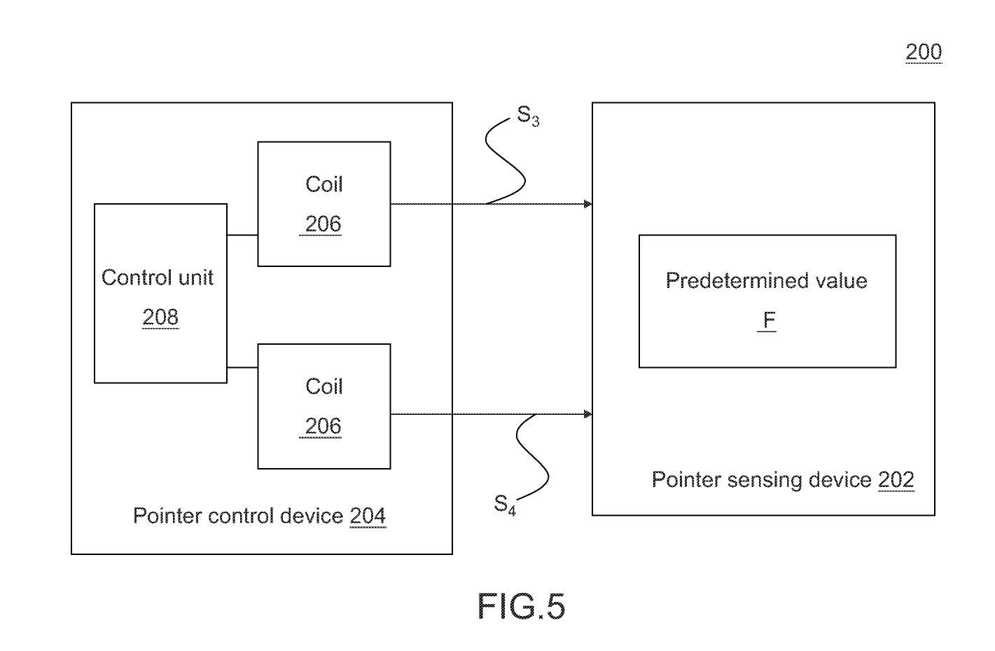

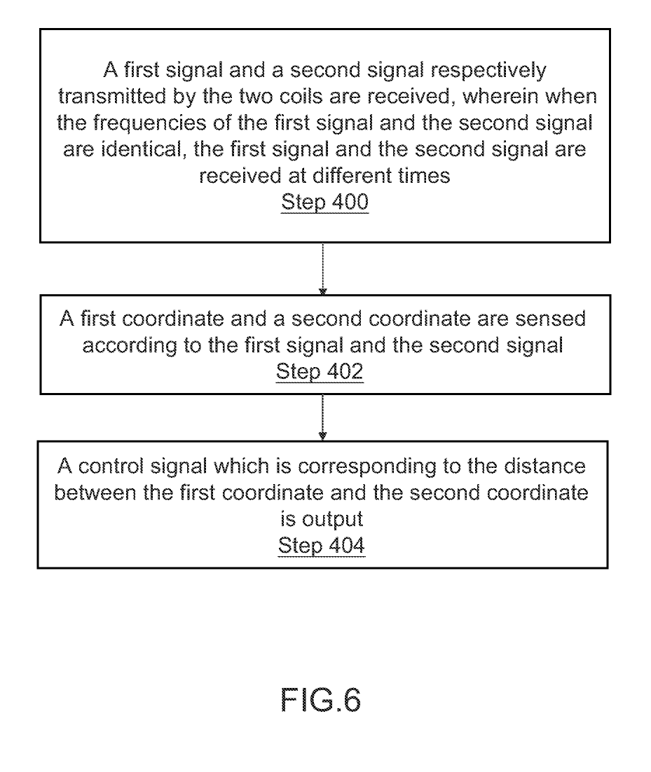

FIG. 4, FIG. 5 and FIG. 6 are respectively a schematic three-dimensional structural view of another embodiment of the pointer control system according to the present invention, a circuit block diagram of the pointer control system, and a flow chart of a pointer control method according to FIG. 5. The pointer control system 200 is applied to control a pointer (not shown), and comprises a pointer sensing device 202 and a pointer control device 204. The pointer sensing device 202 may be, but not limited to, a wireless Tablet, and the pointer control device 204 may be, but not limited to, a wireless digital pen. The pointer control device 204 comprises two coils 206 and a control unit 208, and the two coils 206 are spaced by a distance X. A first signal S₃ and a second signal S₄ respectively transmitted by the two coils 206 are received, wherein when the frequencies of the first signal S₃ and the second signal S₄ are identical, the first signal S₃ and the second signal S₄ are received at different times (Step 400). In other words, when the frequencies of the first signal S₃ and the second signal S₄ are identical, the control unit 208 staggers the time when the first signal S₃ and the second signal S₄ are transmitted to the pointer sensing device 202, so that the pointer sensing device 202 receives the first signal S₃ and the second signal S₄ at different times to avoid interference with each other. However, this embodiment is not intended to limit the present invention.

A first coordinate P₃ and a second coordinate P₄ are sensed according to the first signal S₃ and the second signal S₄ (Step 402). In other words, after receiving the first signal S₃ and the second signal S₄, the pointer sensing device 202 senses the first coordinate P₃ and the second coordinate P₄. The first coordinate P₃ and the second coordinate P₄ are respectively absolute coordinates of the two coils 206 on the pointer sensing device 202 when the two coils 206 send the first signal S₃ and the second signal S₄. Since the two coils 206 are spaced by a distance X, when an angle α is formed between the pointer sensing device 202 and the pointer control device 204, a distance Y exists between the first coordinate P₃ and the second coordinate P₄.

A control signal which is corresponding to the distance Y between the first coordinate P₃ and the second coordinate P₄ is output (Step 404). In other words, the pointer sensing device 202 obtains an inclination angle value (not shown) according to the distance Y, and further outputs the control signal (not shown) which is corresponding to the inclination angle value. Since the pointer sensing device 202 outputs the control signal which is corresponding to the distance Y, the angle α formed between the pointer control device 204 and the pointer sensing device 202 may range from zero to 90 degrees. When the angle α formed between the pointer control device 204 and the pointer sensing device 202 is larger, the distance Y between the first coordinate P₃ and the second coordinate P₄ is shorter. When the angle α formed between the pointer control device 204 and the pointer sensing device 202 is smaller, the distance Y between the first coordinate P₃ and the second coordinate P₄ is longer. When the angle α is 90 degrees, the first coordinate P₃ coincides with the second coordinate P₄.

In this embodiment, the pointer sensing device 202 may comprise, but is not limited to, a predetermined value F. When the inclination angle value is larger than the predetermined value F, the pointer sensing device 202 outputs a first control signal (not shown). When the inclination angle value is smaller than or equal to the predetermined value F, the pointer sensing device 202 outputs a second control signal (not shown). The inclination angle value may be a numerical value that indicates the angle α formed between the pointer sensing device 202 and the pointer control device 204. The predetermined value F may be a numerical value indicating that the angle α formed between the pointer sensing device 202 and the pointer control device 204 is 30 degrees. This embodiment is not intended to limit the present invention. When the angle α formed between the pointer sensing device 202 and the pointer control device 204 is smaller, the inclination angle value may be smaller; while when the angle α formed between the pointer sensing device 202 and the pointer control device 204 is larger, the inclination angle value may be greater. This embodiment is not intended to limit the present invention.

According to the pointer control device, system and method disclosed in the present invention, the operation mode of the pointer can be controlled through the control signal which is corresponding to the distance between the first coordinate and the second coordinate that are sensed by the pointer sensing device. For example, when the pointer control system is applied in the operation of the graphic software, the change of the distance between the first coordinate and the second coordinate may cause the pointer to change the mode of the pencil brush or the thickness of the lines; and furthermore, the pointer control system may compensate the displacement caused by the mere change of the angle. Therefore, the pointer control device, system and method of the present invention can solve the problems of the conventional pointer control system (Tablet system). Moreover, when the frequencies of the first signal and the second signal sent by the two coils are different, the first signal and the second signal are received by the pointer sensing device at the same time. When the frequencies of the first signal and the second signal sent by the two coils are identical, the first signal and the second signal are received by the pointer sensing device at different times through the control unit of the pointer control device, so as to avoid a sensing error of the pointer sensing device caused by interference with each other.

What is claimed is:

1. A pointer control system, applied to control a pointer, comprising:
a pointer sensing device; and
a pointer control device, comprising two coils, wherein the coils respectively transmit a first signal and a second signal to the pointer sensing device, so that the pointer sensing device respectively senses a first coordinate and a second coordinate;
wherein the pointer sensing device obtains an inclination angle value according to a relativity between the first coordinate and the second coordinate, and further outputs a control signal which is corresponding to the inclination angle value.

2. The pointer control system according to claim 1, wherein the pointer control device further comprises a control unit, the frequencies of the first signal and the second signal are identical, and the control unit staggers the time when the first signal and the second signal are transmitted to the pointer sensing device, so that the pointer sensing device receives the first signal and the second signal at different times.

3. The pointer control system according to claim 1, wherein when the frequencies of the first signal and the second signal are different, the pointer sensing device receives the first signal and the second signal at the same time.

4. The pointer control system according to claim 1, wherein the pointer sensing device comprises a predetermined value, and when the inclination angle value is larger than the predetermined value, the pointer sensing device outputs a first control signal; while when the inclination angle value is smaller than or equal to the predetermined value, the pointer sensing device outputs a second control signal.

5. A pointer control device, applied in a pointer sensing device, comprising:
two coils, for respectively transmitting a first signal and a second signal to the pointer sensing device, so that the pointer sensing device is enabled to sense a first coordinate and a second coordinate respectively, wherein a distance between the first coordinate and the second coordinate is related to an angle formed between the pointer control device and the pointer sensing device.

6. The pointer control device according to claim 5, wherein the pointer control device further comprises a control unit, the frequencies of the first signal and the second signal are identical, and the control unit staggers the time when the first signal and the second signal are transmitted to the pointer sensing device, so that the pointer sensing device receives the first signal and the second signal at different times.

7. The pointer control device according to claim 5, wherein the frequencies of the first signal and the second signal are different, and the pointer sensing device receives the first signal and the second signal at the same time.

8. A pointer control method, comprising:
receiving a first signal and a second signal transmitted by two coils respectively;
sensing a first coordinate and a second coordinate according to the first signal and the second signal; and
outputting a control signal which is corresponding to a distance between the first coordinate and the second coordinate.

9. The pointer control method according to claim 8, wherein when the frequencies of the first signal and the second signal are different, the first signal and the second signal are received at the same time.

10. The pointer control method according to claim 8, wherein when the frequencies of the first signal and the second signal are identical, the first signal and the second signal are received at different times.
